(19) United States
(12) Patent Application Publication
(10) Pub. No.: US 2017/0142372 A1
(43) Pub. Date: May 18, 2017

(54) METHOD OF DISPLAYING SURVEILLANCE VIDEO AND COMPUTER PROGRAM PRODUCT THEREFOR

(71) Applicant: VIVOTEK INC., New Taipei City (TW)

(72) Inventor: Chin-Wei Cho, New Taipei City (TW)

(21) Appl. No.: 15/299,436

(22) Filed: Oct. 20, 2016

(30) Foreign Application Priority Data
Nov. 12, 2015 (TW) 104137284

(51) Int. Cl. H04N 7/18; H04N 21/472; H04N 5/262; H04N 21/4728

(52) U.S. Cl. CPC H04N 7/18; H04N 21/4728; H04N 21/47205; H04N 5/2628

(57) ABSTRACT

A method of displaying surveillance video is used for displaying a video relative to a scene on a displaying area of a displaying screen of a portable electronic apparatus. The method includes displaying the video on the displaying area in a frame size which is larger than the displaying area, setting at least one region of interest relative to the scene in response to at least one corresponding setting operation by a user; and in response to a selection operation on the at least one region of interest by the user, retrieving at least one sub-video from the video corresponding to the selected at least one region of interest and enlarging the at least one sub-video on the displaying area. Thereby, the user can effectively monitor the scene through the size-limited displaying area.

### BACKGROUND OF THE INVENTION

1. Field of the Invention

The invention relates to a method of displaying surveillance video and a computer program product for execution of the method, and especially relates to a method of displaying surveillance video performed on a portable electronic apparatus and a computer program product thereof.

2. Description of the Prior Art

A conventional frame size for displaying conventional surveillance videos is usually equal in ratio to the size of common screens, so the screen just can display the whole video. There are various panoramic cameras of 180, 270 and 360 degrees available on the market. The panoramic image frames of surveillance videos thereof show a wider aspect ratio than that of the screen size. If the whole surveillance video is required to be displayed within the same screen, the surveillance video needs to be shrunk to be displayed; it is inconvenient for users to watch. Furthermore, in the case, the surveillance video is displayed in a low resolution, which also causes difficult surveillance for the users. When the surveillance video is displayed on a portable electronic apparatus (such as smartphones), the above problems will be worse. If the panoramic image frames are enlarged to be displayed, the whole panoramic image frame cannot be displayed on the screen of the portable electronic apparatus at the same time. Hence, the user has to make the panoramic image frame to move to be displayed on the screen portion by portion for watching all portions of the panoramic image frame. In a situation of a practical video surveillance, not all portions of the panoramic image frame need to be watched; in general, only several important regions of the panoramic image frame need to be watched. When the panoramic image frame is enlarged to be displayed, the important regions cannot be showed on the screen at the same time, which also causes difficult surveillance for the user. Furthermore, if the user wants to switch between the important regions for surveillance, the switching operation also make the surveillance inconvenient for the user.

### SUMMARY OF THE INVENTION

An objective of the invention is to provide a method of displaying surveillance video, by which a user can quickly watch enlarged images relative to regions of interest on a screen by setting and selecting the regions of interest relative to a scene.

A method of displaying surveillance video according to invention is used for displaying a video relative to a scene on a displaying area of a displaying screen of a portable electronic apparatus. The method of displaying surveillance video includes the following steps: (a) displaying the video on the displaying area in a frame size which is larger than the displaying are; (b) setting at least one region of interest relative to the scene in response to at least one corresponding setting operation by a user; and (c) in response to a selection operation on the at least one region of interest by the user, retrieving at least one sub-video from the video corresponding to the selected at least one region of interest by the user and enlarging the at least one sub-video on the displaying area. Thereby, after setting the at least one region of interest, the user can watch enlarged images relative to the at least one region of interest on the displaying screen by selecting at least one from the at least one region of interest. Therefore, the user can perform effective surveillance of the scene.

Another objective of the invention is to provide a computer program product for displaying a video relative to a scene on a displaying area of a displaying screen of a portable electronic apparatus. The computer program product includes computer executable code embodied on a non-transitory computer readable storage medium. When executed on the portable electronic apparatus, the computer executable code performs the following steps: (a) displaying the video on the displaying area in a frame size, the frame size being larger than the displaying are; (b) setting at least one region of interest relative to the scene in response to at least one corresponding setting operation by a user; and (c) in response to a selection operation on the at least one region of interest by the user, retrieving at least one sub-video from the video corresponding to the selected at least one region of interest by the user and enlarging the at least one sub-video on the displaying area. Similarly, when executed on the portable electronic apparatus, the computer executable code allows the user to set the at least one region of interest and select at least one from the at least one region of interest so that the user can watch enlarged images relative to the at least one region of interest on the displaying screen. Therefore, the user can perform effective surveillance of the scene.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a portable electronic apparatus of an embodiment according to the invention.

FIG. 2 is a function block diagram of the portable electronic apparatus in FIG. 1.

FIG. 3 is a schematic diagram illustrating an image frame of a video relative to a scene.

FIG. 4 is a flow chart of a method of displaying surveillance video according to the invention.

FIG. 5 is schematic diagram illustrating a relationship between the portable electronic apparatus in FIG. 1 and the image frame of the video.

FIG. 6 is a front view of the portable electronic apparatus in FIG. 1 which displays a single sub-video.

FIG. 7 is a front view of the portable electronic apparatus in FIG. 1 which displays four sub-videos.

FIG. 8 is a flow chart of a method of displaying surveillance video of an embodiment according to the invention.

FIG. 9 is a front view of the portable electronic apparatus which pans the video.

FIG. 10 is a front view of the portable electronic apparatus which displays an input box corresponding to a rectangular border.

FIG. 11 is a flowchart of a method of displaying surveillance video of another embodiment according to the invention.

FIG. 12 is a front view of the portable electronic apparatus which displays thumbnails in a matrix displaying way.

FIG. 13 is a front view of the portable electronic apparatus which displays thumbnails in a card displaying way.

### DETAILED DESCRIPTION

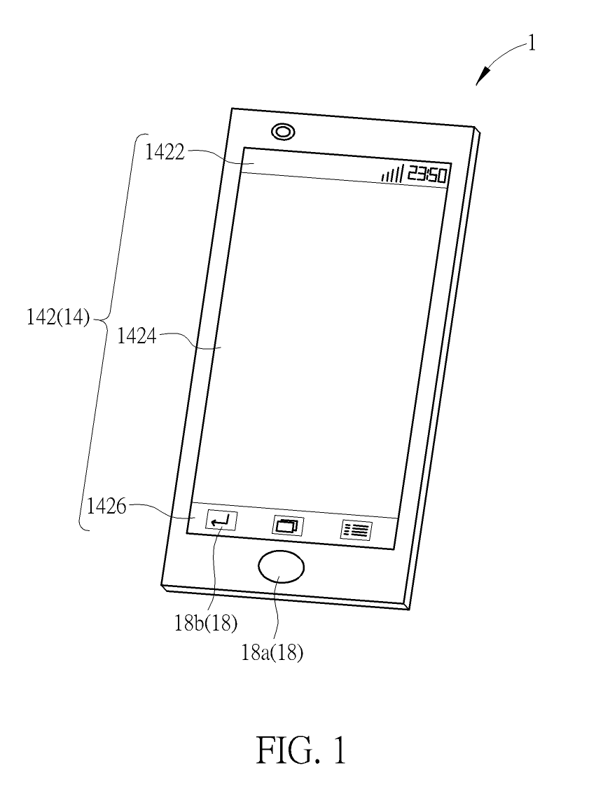

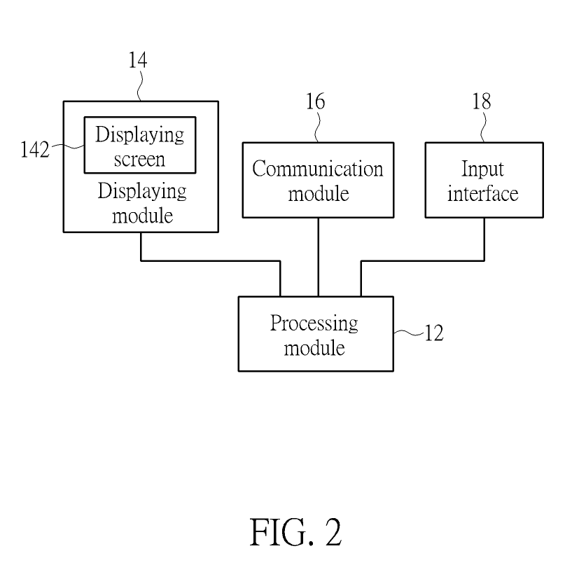

Please refer to FIG. 1 and FIG. 2. A portable electronic apparatus 1 includes a processing module 12, a displaying module 14, a communication module 16, and an input interface 18. The processing module 12 is electrically connected to the displaying module 14, the communication module 16, and the input interface 18. The displaying module 14 includes a displaying screen 142 for displaying images thereon. The communication module 16 is used for communicate with external devices. The input interface 18 is used for receiving external input operations such as operations (e.g. touch operation, pressing or touching substantial or virtual buttons) performed on the portable electronic apparatus 1 by a user. In practice, the input interface 18 can include a substantial button 18a, virtual buttons 18b (which can be realized by the displaying module 14 displaying button icons in coordination with a sensing module e.g. a touch panel capable of sensing touch performed on the displaying screen 142), and a touch module capable of receiving touch operations (including point touch, sliding touch and so on). In the embodiment, the portable electronic apparatus 1 is illustrated by a smartphone which uses a touch and display module which can perform both displaying and touch sensing. For simplification of labeling the elements, the touch and display module is labeled with the displaying module 14, and the touch panel for the input interface 18 is not labeled in addition. Furthermore, in the embodiment, the displaying screen 142 includes an upper indication area 1422, a displaying area 1424, and a lower functional area 1426. The upper indication area 1422 is used for displaying the system status such as time, battery remnant, signal intensity and so on. The lower functional area 1426 is used for displaying the icons of the virtual buttons 18b; therein, for convenience in the description, the virtual buttons 18b are presented directly by the icons. Furthermore, when a virtual keyboard is displayed on the displaying area 1424, the virtual keyboard is part of the input interface 18. In addition, the invention also can be applied to other portable electronic apparatuses such as tablet computers, notebooks, and wearable electronic apparatuses. Therein, input devices such as a keyboard, a touch pad, a mouse used in a notebook are part of the input interface 18. Furthermore, when the invention is applied to a notebook, the touch operations performed on the displaying screen 142 in the above embodiment can be performed through the touch pad or mouse, which will not be described in addition. In addition, according to an architecture of a common smartphone, the processing module 12, the communication module 16, and are usually realized by a circuit main board with electronic components thereon for performing needed functions such as processing data, communicating with external devices, controlling displaying panel to display images, receiving external input through an input interface, and so on. The displaying module 14 includes a display panel (e.g. LCD panel) and a control circuit therefor; in practice, the latter is usually integrated into the circuit main board, and the former is another electronic component electrically connected to the circuit main board e.g. through a flexible cable. The input interface 18 may include substantial buttons, virtual buttons, and sensors and is usually realized in coordination with the circuit main board and the displaying module 14; therefore, the input interface 18 is usually integrated into the circuit main board and the displaying module 14. For example, the virtual buttons, and sensors are integrated into the displaying module 14; thereby, the circuit main board can receive external input through the virtual buttons integrated into the displaying module 14. The substantial buttons are integrated onto the circuit main board, for example by mounting corresponding switches on the circuit main board so that the circuit main board can sense the statuses of the switches for receiving external input through the substantial buttons of the input interface 18.

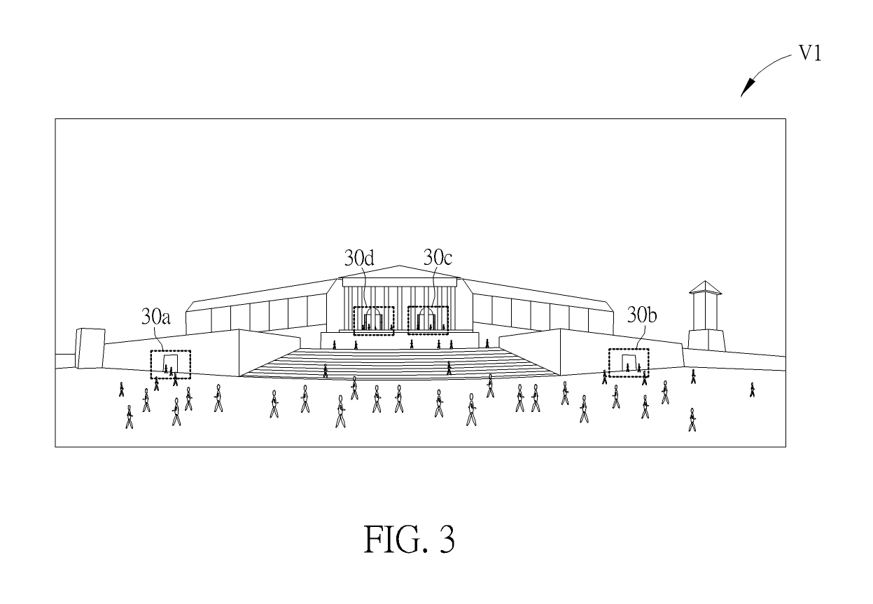

A video V1 shows images of a scene in front of a large building, as shown by FIG. 3. In the embodiment, the images are recorded in panoramic images, for example by a panoramic camera, but the invention is not limited thereto. The video V1 can be delivered immediately or be stored in a storage equipment (e.g. a network server) in advance and then delivered by request. The processing module 12 of the portable electronic apparatus 1 can control the communication module 16 to receive the video V1 from a remote device (e.g. the above panoramic camera or the network server) through a network. The processing module 12 can also control the displaying module 14 to display the video on the displaying area 1424 of the displaying screen 142 for a user to watch.

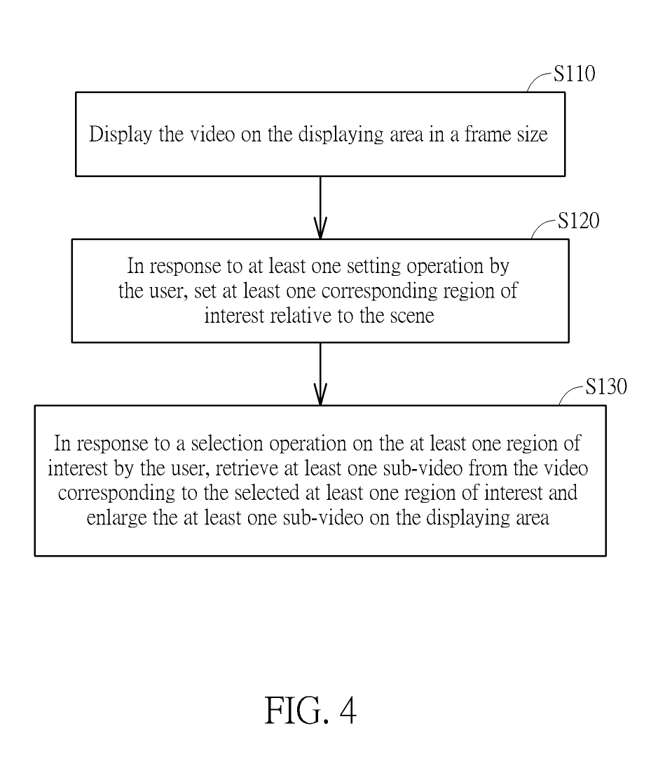

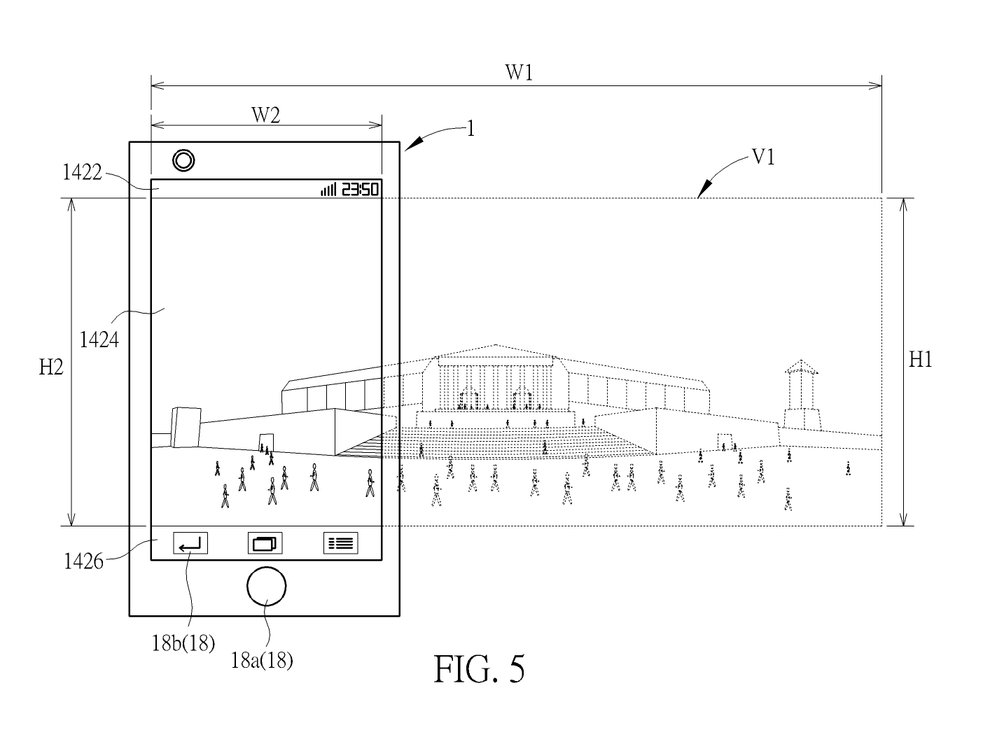

Please refer to FIG. 4 which is a flow chart of a method of displaying surveillance video according to the invention. For simplification, the description in the following for the method is based on the portable electronic apparatus 1 and the video V1 for example. For the description of the portable electronic apparatus 1 and the video V1, please refer to the above descriptions and the relevant figures, which will be not described in addition. After the portable electronic apparatus 1 receives the video V1, the method of displaying surveillance video according to the invention is to display the video V1 on the displaying area 1424 in a frame size which is larger than the size of the displaying area 1424, as shown by the step 5110. That is, the processing module 12 controls the displaying module 14 to display the video V1 on the displaying area 1424 in the frame size. Because the frame size is larger than that of the displaying area 1424, only a portion of each image frame of the video V1 is seen through the displaying area 1424 at the same time, as shown by FIG. 5. Therein, for clear understanding of displaying the video V1 on the displaying area 1424, in FIG. 5, the portion of the image frame of the video V1 that is not displayed on the displaying area 1424 is shown in dashed lines. The user still can see all portions of the image frame of the video V1 through the displaying area 1424 by a frame moving operation. As shown by FIG. 5, the user can move the video V1 along a single direction for seeing all portions of the image frame of the video V1; however, the invention is not limited thereto. For example, the user may need to pan the image frame in two directions for seeing all portions of the image frame of the video V1. In addition, in practice, when the method of displaying surveillance video is executed, the method also can set all the displaying screen 142 to be the displaying area 1424; that is, the original displaying area 1424 expands upward and downward to the visible extent of the displaying screen 142, in which the upper indication area 1422 and the lower functional area 1426 are not shown or hidden.

Afterwards, the method of displaying surveillance video is to set at least one region of interest relative to the scene in response to at least one corresponding setting operation by the user, as shown by the step S120. That is, the processing module 12 sets the at least one region of interest relative to the scene in response to the at least one corresponding setting operation performed through the portable electronic apparatus 1 by the user. As shown by the scene in FIG. 3, the user may be interested in a few area of the scene, e.g. left and right sides of the plaza in front of the building, an inlet and an outlet of the building, and so on. In the meanwhile, the user can perform setting four times (i.e. four setting operations) through the portable electronic apparatus 1 and then get four corresponding regions of interest.

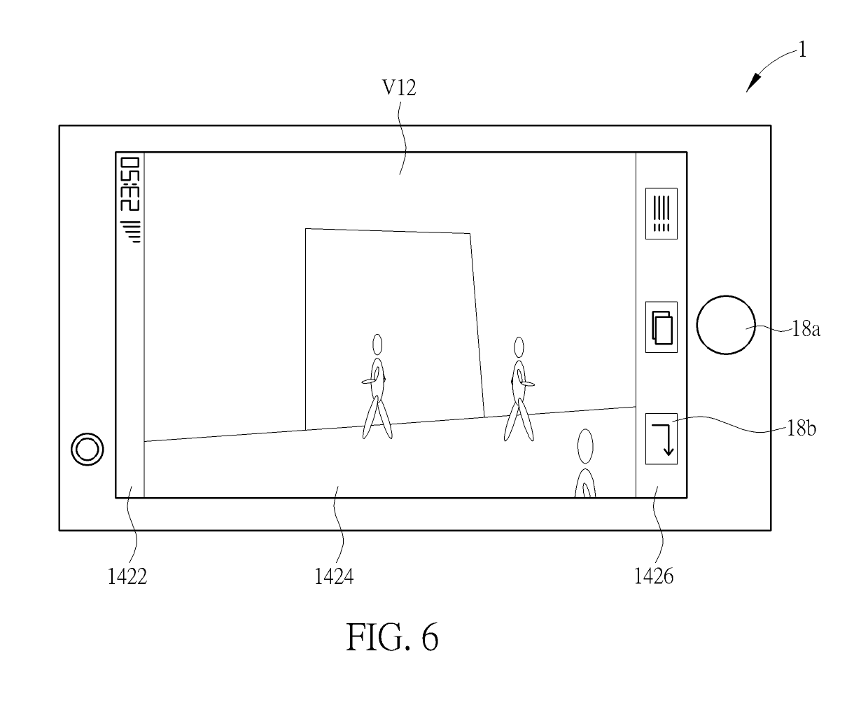

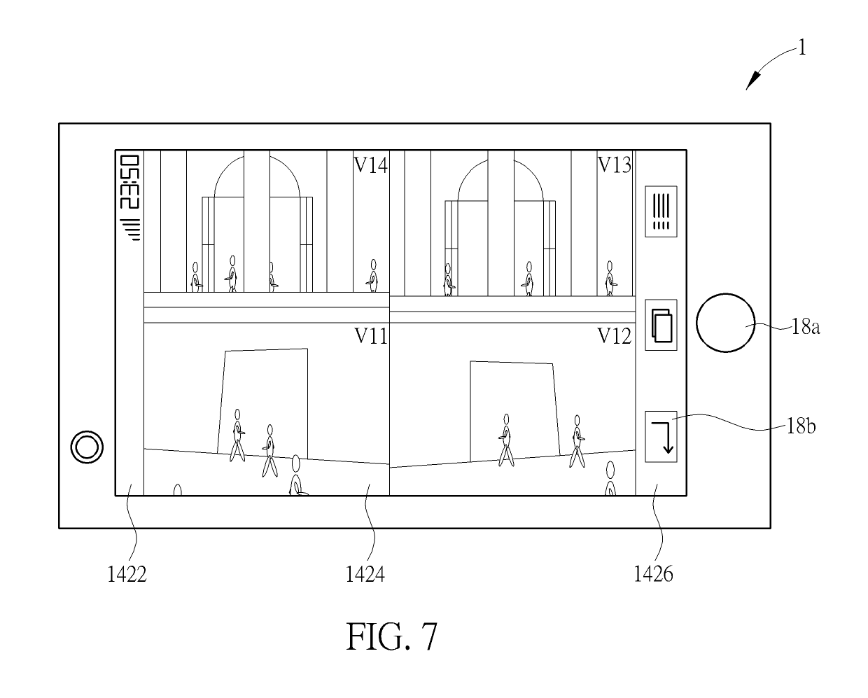

Afterwards, in response to a selection operation on the at least one region of interest by the user, the method of displaying surveillance video is to retrieve at least one sub-video from the video V1 corresponding to the selected at least one region of interest by the user and enlarge the at least one sub-video on the displaying area 1424, as shown by the step S130. That is, in response to the selection operation on the at least one region of interest performed through the portable electronic apparatus 1 by the user, the processing module 12 retrieves the at least one sub-video from the video V1 corresponding to the selected at least one region of interest by the user and controls the displaying module 14 to enlarge the at least one sub-video on the displaying area 1424. Therein, for enlarging the sub-video on the displaying area 1424, the sub-video is displayed on the displaying area 1424 in a larger scale than the sub-image corresponding to the selected region of interest is displayed on the displaying area 1424. Based on the above example of the four regions of interest, the user can perform selection on the four regions of interest through the portable electronic apparatus 1. If the user selects only one of the four regions of interest, e.g. the right side of the plaza, the processing module 12 enlarges the corresponding sub-video on the whole extent of the displaying area 1424 in principle, as shown by FIG. 6. Therein, the processing module 12 controls the displaying module 14 to display the corresponding sub-video by a 90 degree rotation for a better enlarged displaying effect; however, the invention is not limited thereto. Furthermore, if the user selects the four regions of interest, the processing module 12 controls the displaying module 14 to enlarge and simultaneously display the sub-videos corresponding to the four regions of interest and display on the displaying area 1424 in a proper arrangement, as shown by FIG. 7. In practice, the step S130 can be executed repeatedly in response to operation by the user, so that the user can switch the displayed content on the displaying area 1424 between the regions of interest. In addition, in FIG. 6 and FIG. 7, for simplification of the description, the aspect ratios of the sub-videos are equal to the aspect ratios of the corresponding regions of interest and the aspect ratio of the displaying area 1424 (or that of the displaying area 1424 with a 90 degree rotation). Therefore, the extent of the displaying area 1424 can be filled up with the enlarged images of the corresponding sub-videos (no matter with one or four image frames corresponding to the one or four sub-videos), which fully uses the displaying area 1424; however, the invention is not limited thereto. Practical details of the method of displaying surveillance video will be described later. In addition, in principle, the retrieved sub-video is a video formed by partial images relative to the corresponding region of interest from the images in the video V1. The displaying of the sub-video can be achieved by displaying only the partial images relative to the corresponding region of interest in the video V1, so it is not necessary to form an isolated video (isolated from the video V1) as the sub-video.

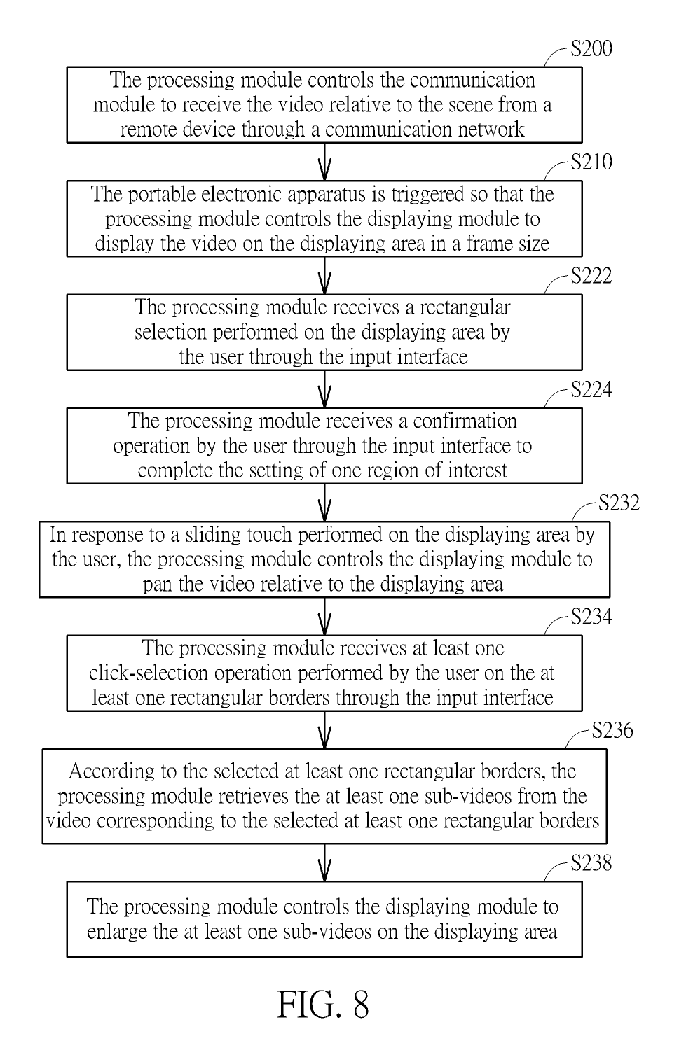

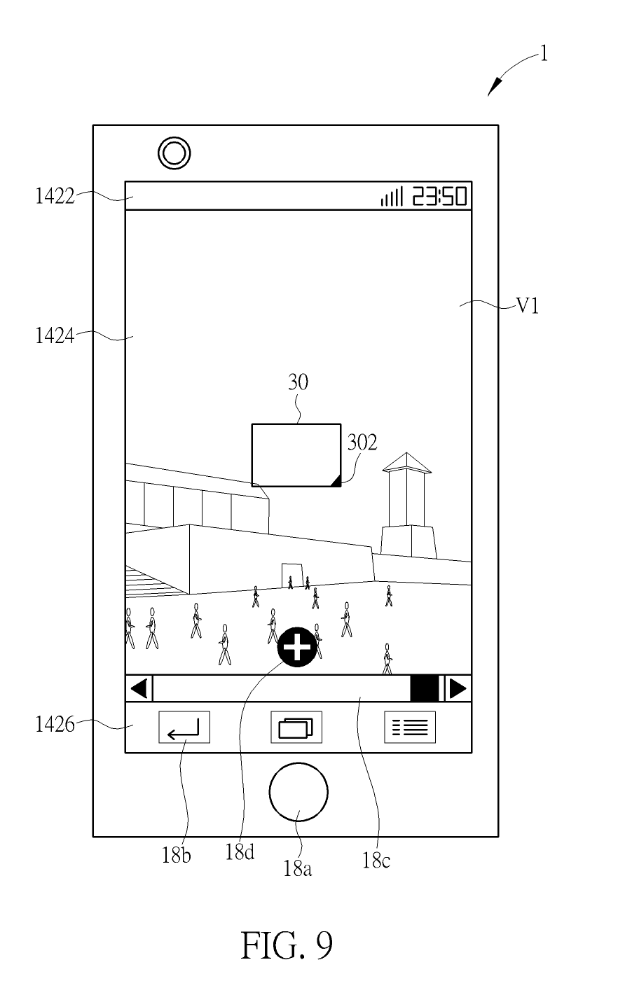

Please refer to FIG. 8 which is a flow chart of a method of displaying surveillance video of an embodiment according to the invention. Similarly, for simplification, the description in the following for the method is based on the portable electronic apparatus 1 and the video V1 for example. For the description of the portable electronic apparatus 1 and the video V1, please refer to the above descriptions and the relevant figures, which will be not described in addition. As shown by FIG. 8, in the embodiment, the processing module 12 of the portable electronic apparatus 1 controls the communication module 16 to receive the video V1 relative to the scene from a remote device (e.g. a panoramic camera) through a communication network (e.g. a telecommunication network or Internet), as shown by the step S200. In practice, the received video V1 may not be displayed instantly for watch and can be stored in a storage component in the portable electronic apparatus 1 or peripheral storage devices. When the user wants to watch the video V1 (e.g. for surveillance of the scene), the user can trigger the portable electronic apparatus 1 (e.g. to execute a surveillance program) so that the processing module 12 controls the displaying module 14 to display the video V1 on the displaying area 1424 in a frame size which is larger than the displaying area 1424, as shown by the step S210 and FIG. 5. In the embodiment, the image frame of the video V1 shows a transverse rectangle (e.g. having a wider aspect ratio). A height H1 of the frame size is equal to a height H2 of the displaying area 1424; a width W1 of the frame size is larger than a width W2 of the displaying area 1424. Therefore, the user can move the image frames of the video V1 by a transversely panning operation through the portable electronic apparatus 1, so that the user can see all portions of the video V1. Furthermore, in the embodiment, the displaying area 1424 displays the video V1 in a longitudinal position, so the height H2 is larger than the width W2 so that the video V1 can be enlarged to be displayed on the displaying area 1424 (relative to the case that the displaying area 1424 displays the video V1 in a transverse position). In practice, the processing module 12 of the portable electronic apparatus 1 controls the displaying module 14 to display the video V1 on the displaying area 1424 in a sliding mode. The user can perform a sliding touch directly on the displaying area 1424 or operate a scroll 18c (which covers a portion of the image frame of the video V1, as shown by FIG. 9) displayed below the displaying area 1424 for triggering the processing module 12 to control the displaying module 14 to transversely slide the image frame of the video V1. Therefore, in the embodiment, the portable electronic apparatus 1 pans the video V1 relative to the displaying area 1424 according to the sliding mode in response to a sliding touch on the displaying area 1424 by the user (e.g. using a finger to sliding over the displaying area 1424 in a distance). For the other descriptions for the step S210, please refer to the relevant descriptions of the step S110, which will not be described in addition.

When the user wants to set some areas of the scene to be regions of interest, the user can complete it by the setting operation described in the step S120. In the embodiment, the processing module 12 receives a rectangular selection performed on the displaying area 1424 by the user through the input interface 18, as shown by the step S222. In practice, the processing module 12 can control the displaying module 14 to display an adding button icon 18d on the displaying area 1424 (as shown by FIG. 9). When the processing module 12 receives a triggering operation on the adding button icon 18d (e.g. pressing or touching the adding button icon 18d) through the input interface 18, the step S222 is executed accordingly. In an embodiment, the step S222 can include the processing module 12 controlling the displaying module 14 to display a rectangular border 30 on the displaying area 1424 (as shown by FIG. 9) and in response to an adjustment operation on the rectangular border 30 by the user, controlling the displaying module 14 to adjust the rectangular border 30 and display the adjusted rectangular border 30 on the displaying area 1424. In practice, the user can drag four boundary edges of the rectangular border 30 to adjust the size of the rectangular border 30 for performing the above adjustment operation. Furthermore, if the rectangular border 30 includes an adjusting icon 302 (as shown by a triangle at the lower right corner of the rectangular border 30 in FIG. 9), the user can trigger the adjusting icon 302 to make the rectangular border 30 at an adjustable state and then perform the above adjustment operation, for example by dragging the adjusting icon 302 to change the size of the rectangular border 30 or by panning the rectangular border 30 and adjusting the size of the rectangular border 30 only after the adjusting icon 302 is triggered. Furthermore, after the adding button icon 18d is triggered, the rectangular border 30 can be originally displayed at the center portion of the displaying area 1424, or in response to a touch operation (e.g. a rectangle drawing operation of dragging out a rectangle in a drafting software) performed on the displaying area 1424 by the user, the processing module 12 controls the displaying module 14 to display the rectangular border 30 on the displaying area 1424.

Furthermore, in practice, the user sets the rectangular border 30 according to the video V1 such that the rectangular border 30 substantially encloses an area interesting the user, e.g. left and right sides of the plaza in front of the building, an inlet and an outlet of the building, and so on. When the user wants to abandon the rectangular border 30, the user can perform a touch operation (e.g. single contact) on the displaying area 1424 outside the rectangular border 30 before the following confirmation step (i.e. the step S224) is executed. After receiving the touch operation through the input interface 18, the processing module 12 controls the displaying module 14 to remove the rectangular border 30 on the displaying area 1424. The user can repeat the rectangular selection in the step S222 for obtaining another rectangular border 30.

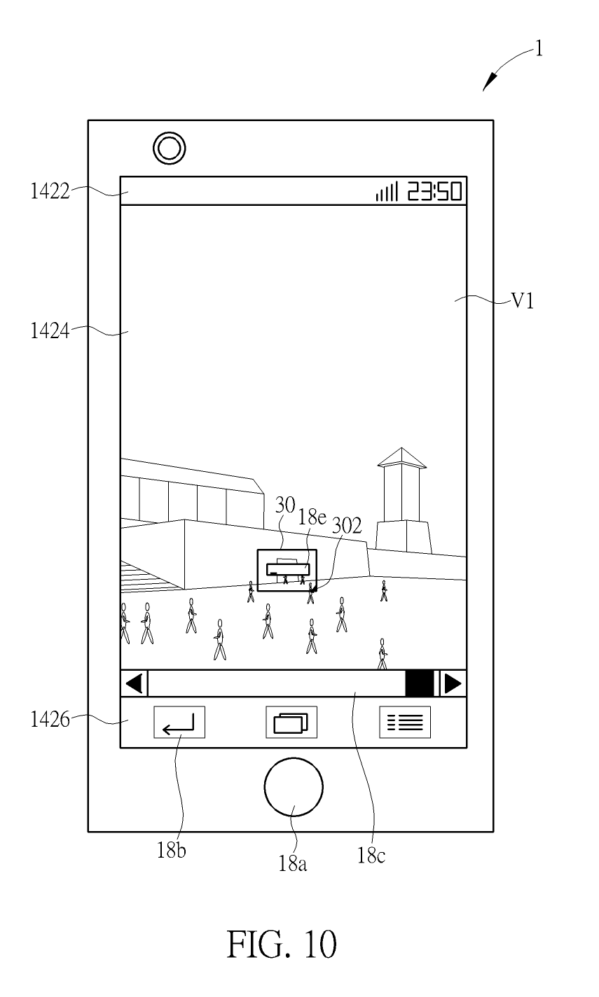

After the user decides the size and position of the rectangular border 30, the processing module 12 receives a confirmation operation by the user through the input interface 18 to complete the setting of one region of interest, as shown by the step S224. In an embodiment, the step S224 includes when receiving a touch operation inside the rectangular border 30 through the input interface 18, the processing module 12 controlling the displaying module 14 to display an input box 18e on the displaying area 1424 (as shown by FIG. 10), the processing module 12 receiving a name inputted through the input box 18e, and the processing module 12 assigning the name to the region of interest corresponding to the rectangular border 30. In this case, the extent enclosed by the rectangular border 30 is the extent of the corresponding region of interest, and the setting of one region of interest is therefore completed. If the user wants to set a plurality of regions of interest, the steps S222 and S224 can be executed repeatedly (and the video V1 may need to be panned, as the case may be; therein, for the details of the panning operation, please refer to the above descriptions relative to the step S210, which will not be described in addition).

Furthermore, in practice, the step S224 can include after the assignment of the name, the processing module 12 controlling the displaying module 14 to display a rectangular border corresponding to the region of interest on the displaying area 1424; therein, the rectangular border is displayed by semi opaque lines. For simplification of the description, in the embodiment, there are four regions of interest which are left and right sides of the plaza in front of the building, an inlet and an outlet of the building, as shown by FIG. 3; therein, the semi opaque rectangular borders 30a-d (shown by dashed lines in FIG. 3) correspond to the four regions of interest respectively.

When the user wants to enlarge one or more of the set regions of interest for convenience of surveillance, the user can perform the selection operation in the step S130. In the embodiment, in response to a sliding touch performed on the displaying area 1424 by the user, the processing module 12 controls the displaying module 14 to pan the video V1 relative to the displaying area 1424, as shown by the step S232. Therein, the rectangular borders 30a-d are also moved as the video V1 is panned. Thereby, the user can see the semi opaque rectangular borders 30a-d (for indicating the corresponding regions of interest) through the displaying area 1424, which facilitates the selection by the user. Afterwards, the processing module 12 receives at least one click-selection operation performed by the user on the at least one rectangular borders 30a-d through the input interface 18, as shown by the step S234. According to the selected at least one rectangular borders 30a-d, the processing module 12 retrieves the at least one sub-videos V11-14 from the video V1 corresponding to the selected at least one rectangular borders 30a-d, as shown by the step S236. The processing module 12 controls the displaying module 14 to enlarge the at least one sub-videos V11-14 on the displaying area 1424, as shown by the step S238. In an embodiment, if the user select only one rectangular border 30b (i.e. the right side of the plaza) in the step S234, then the sub-video V12 is displayed in the step S238, as shown by FIG. 6. Furthermore, in another embodiment, if the user selects rectangular borders 30a-d (i.e. all the four regions of interest being selected) in the step S234, then all the sub-videos V11-14 are displayed in the step S238, as shown by FIG. 7. Furthermore, the confirmation for the above click-selection operation (i.e. for confirming that one or more rectangular borders 30a-d are selected at last) can be performed by a virtual button or a specific touch track. For the relevant descriptions relative to the arrangement and displaying of the sub-video V11-14 on the displaying area 1424, please refer to the relevant descriptions in the foregoing, which will not be described in addition.

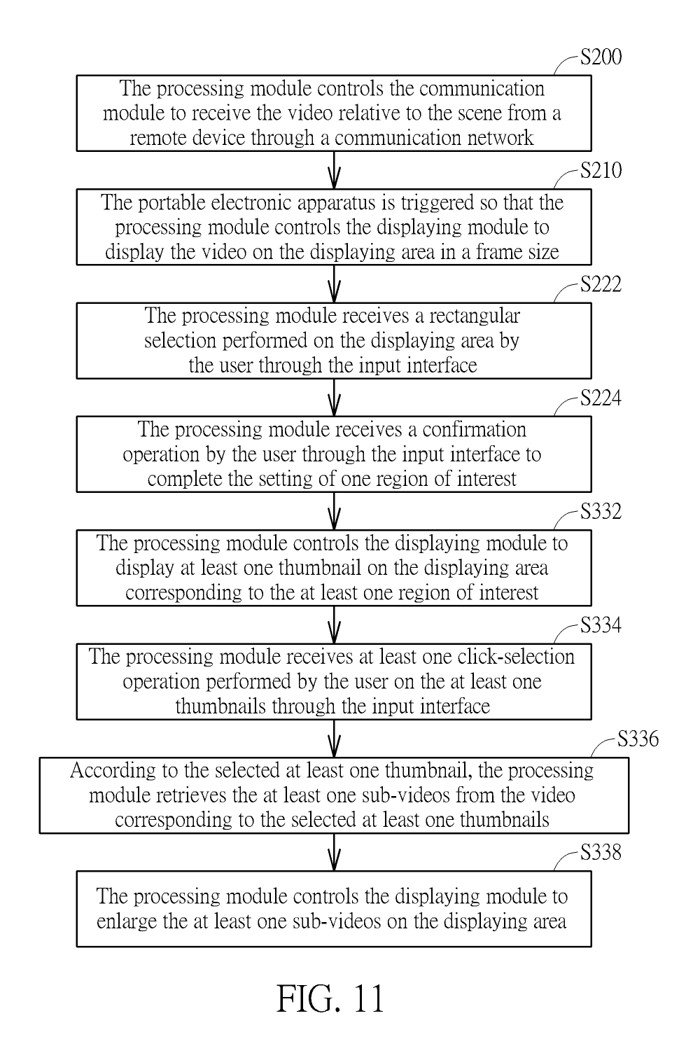

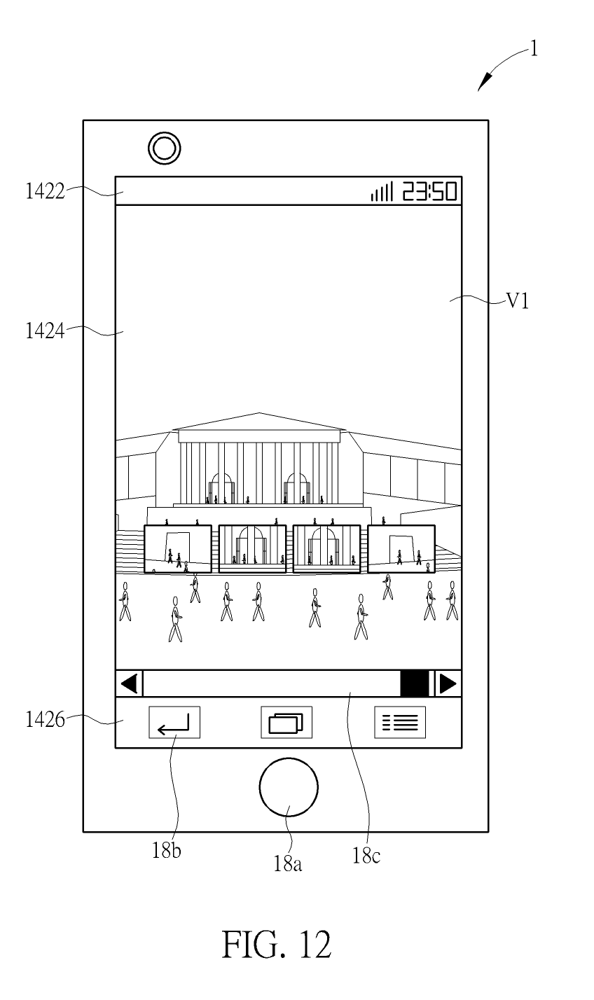

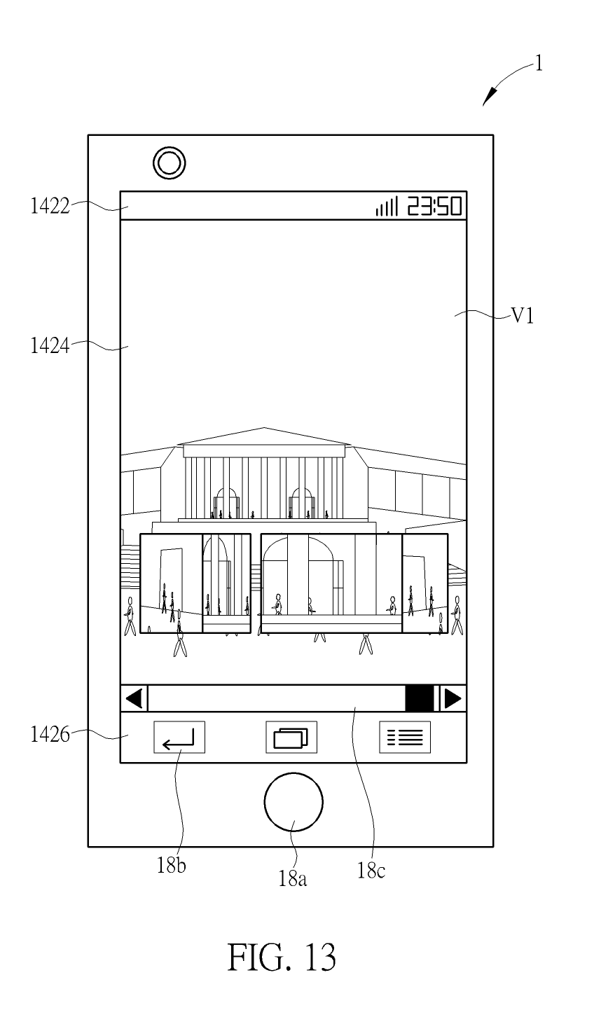

In the above embodiments, the user sees all the video V1 and then selects require ones from the regions of interest (i.e. by click-selecting the rectangular borders 30a-d), but the invention is not limited thereto. Please refer to FIG. 11 which is a flow chart of a method of displaying surveillance video of another embodiment according to the invention. The flow chart in FIG. 11 is similar to the flow chart in FIG. 8; therefore, for other descriptions for the flow chart in FIG. 11, please refer to the relevant descriptions of the flow chart in FIG. 8, which will not be described in addition. In the flow chart in FIG. 11, after the step S224 is executed completely, when the user wants to enlarge one or more of the set regions of interest for convenience of surveillance, the user can perform the selection operation in the step S130. In the embodiment, the processing module 12 controls the displaying module 14 to display at least one thumbnail on the displaying area 1424 corresponding to the at least one region of interest, as shown by the step S332 and FIG. 12; therein, FIG. 12 shows four thumbnails which are displayed in a matrix displaying way on the displaying area 1424 and overlap the video V1 originally displayed on the displaying area 1424. In the embodiment, the four thumbnails are displayed in a single row. In practice, when there are more thumbnails, they can be displayed in more rows. Furthermore, for the cases of displaying in one or more rows, they can be displayed in a plurality of pages and also can be displayed in a transverse displaying length beyond the extent of the displaying area 1424 in coordination with a sliding operation. Furthermore, in practice, it is practicable to display the thumbnails on the displaying area 1424 in a card displaying way, so that the user can perform a touch operation for imitating a flipping motion (e.g. sliding on the displaying area 1424 in a short distance) so as to browse the thumbnails, as shown by FIG. 13. Then, the processing module 12 receives at least one click-selection operation performed by the user on the at least one thumbnails through the input interface 18, as shown by the step S334. According to the selected at least one thumbnail, the processing module 12 retrieves the at least one sub-videos V11-14 from the video V1 corresponding to the selected at least one thumbnails, as shown by the step S336. The processing module 12 controls the displaying module 14 to enlarge the at least one sub-videos V11-14 on the displaying area 1424, as shown by the step S338. Thereby, the user also can make the steps S332, S334, S336 and S338 executed for enlarging the regions of interest, which is conducive to watching the video images relative to the regions. In addition, in practice, the steps S232 and S332 can be performed when the portable electronic apparatus 1 receives a triggering operation by the user. The triggering operation can be a gesture input, a specific touch track, or a pressing on a substantial or virtual button. However, the invention is not limited thereto.

As described above, the method of displaying surveillance video according to the invention is convenient for the user to remote monitor through a portable electronic apparatus. In practice, the method of displaying surveillance video can be performed through a computer program product that records computer executable code that when executed on the portable electronic apparatus, performs method of displaying surveillance video according to the invention. The computer program product is an object carrying the computer executable code thereon; in practice, the object is not limited to a specific exterior shape or structure. When the computer program i.e. the computer executable code is loaded in a computer (e.g. smartphones, tablet computers, notebooks) and is executed by the computer, the details of the performance of the method of displaying surveillance video according to the invention in the above embodiments can be realized.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of displaying surveillance video for displaying a video relative to a scene on a displaying area of a displaying screen of a portable electronic apparatus, the method of displaying surveillance comprising the following steps:
(a) displaying the video on the displaying area in a frame size, the frame size being larger than the displaying are;
(b) setting at least one region of interest relative to the scene in response to at least one corresponding setting operation by a user; and
(c) in response to a selection operation on the at least one region of interest by the user, retrieving at least one sub-video from the video corresponding to the selected at least one region of interest by the user and enlarging the at least one sub-video on the displaying area.

2. The method of claim 1, wherein in the step (c), a height of the frame size is equal to a height of the displaying area, and a width of the frame size is larger than a width of the displaying area.

3. The method of claim 1, wherein in the step (a), the portable electronic apparatus displays the video on the displaying area in a sliding mode.

4. The method of claim 3, wherein in the step (a), the portable electronic apparatus pans the video relative to the displaying area according to the sliding mode in response to a sliding touch on the displaying area by the user.

5. The method of claim 1, wherein the step (b) comprises the following steps:
(b-1) receiving a rectangular selection performed on the displaying area by the user; and
(b-2) receiving a confirmation operation by the user to complete the setting of one region of interest.

6. The method of claim 5, wherein the step (b-1) further comprises displaying a rectangular border on the displaying area corresponding to the rectangular selection, and the step (b-2) comprises the following steps:
when receiving a touch performed inside the rectangular border, displaying an input box on the displaying area;
receiving a name inputted through the input box; and
assigning the name to the region of interest corresponding to the rectangular border.

7. The method of claim 5, further comprising displaying an adding button icon on the displaying area, wherein the step (b-1) is performed when the adding button icon is triggered.

8. The method of claim 5, wherein the step (b-1) comprises the following steps:
displaying a rectangular border on the displaying area; and
in response to an adjustment operation on the rectangular border by the user, adjusting the rectangular border.

9. The method of claim 1, wherein the step (b) comprises displaying at least one rectangular border corresponding to the at least one region of interest, and the step (c) comprises the following steps:
in response to a sliding touch performed on the displaying area by the user, panning the video relative to the displaying area;
receiving at least one click-selection operation performed by the user on the at least one rectangular border;
according to the selected at least one rectangular border, retrieving the at least one sub-video from the video corresponding to the selected at least one rectangular border; and
enlarging the at least one sub-video on the displaying area.

10. The method of claim 1, wherein the step (c) comprises the following steps:
(c-1) displaying at least one thumbnail on the displaying area corresponding to the at least one region of interest;
(c-2) receiving at least one click-selection operation performed by the user on the at least one thumbnail;
(c-3) according to the selected at least one thumbnail, retrieving the at least one sub-video from the video corresponding to the selected at least one thumbnail; and
(c-4) enlarging the at least one sub-video on the displaying area.

11. A computer program product for displaying a video relative to a scene on a displaying area of a displaying screen of a portable electronic apparatus, the computer program product comprising computer executable code embodied on a non-transitory computer readable storage medium, when executed on the portable electronic apparatus, the computer executable code performing the following steps:
(a) displaying the video on the displaying area in a frame size, the frame size being larger than the displaying are;
(b) setting at least one region of interest relative to the scene in response to at least one corresponding setting operation by a user; and
(c) in response to a selection operation on the at least one region of interest by the user, retrieving at least one sub-video from the video corresponding to the selected at least one region of interest by the user and enlarging the at least one sub-video on the displaying area.

12. The computer program product of claim 11, wherein in the step (c), a height of the frame size is equal to a height of the displaying area, and a width of the frame size is larger than a width of the displaying area.

13. The computer program product of claim 11, wherein in the step (a), the portable electronic apparatus displays the video in a sliding mode on the displaying area.

14. The computer program product of claim 13, wherein in the step (a), the portable electronic apparatus pans the video relative to the displaying area according to the sliding mode in response to a sliding touch on the displaying area by the user.

15. The computer program product of claim 11, wherein the step (b) comprises the following steps:
(b-1) receiving a rectangular selection performed on the displaying area by the user; and
(b-2) receiving a confirmation operation by the user to complete the setting of one region of interest.

16. The computer program product of claim 15, wherein the step (b-1) further comprises displaying a rectangular border on the displaying area corresponding to the rectangular selection, and the step (b-2) comprises the following steps:
when receiving a touch performed inside the rectangular border, displaying an input box on the displaying area;
receiving a name inputted through the input box; and
assigning the name to the region of interest corresponding to the rectangular border.

17. The computer program product of claim 15, the computer executable code further performing displaying an adding button icon on the displaying area, wherein the step (b-1) is performed when the adding button icon is triggered.

18. The computer program product of claim 15, wherein the step (b-1) comprises the following steps:
displaying a rectangular border on the displaying area; and
in response to an adjustment operation on the rectangular border by the user, adjusting the rectangular border.

19. The method of claim 11, wherein the step (b) comprises displaying at least one rectangular border corresponding to the at least one region of interest, and the step (c) comprises the following steps:
in response to a sliding touch performed on the displaying area by the user, panning the video relative to the displaying area;
receiving at least one click-selection operation performed by the user on the at least one rectangular border;
according to the selected at least one rectangular border, retrieving the at least one sub-video from the video corresponding to the selected at least one rectangular border; and
enlarging the at least one sub-video on the displaying area.

20. The computer program product of claim 11, wherein the step (c) comprises the following steps:
(c-1) displaying at least one thumbnail on the displaying area corresponding to the at least one region of interest;
(c-2) receiving at least one click-selection operation performed by the user on the at least one thumbnail;
(c-3) according to the selected at least one thumbnail, retrieving the at least one sub-video from the video corresponding to the selected at least one thumbnail; and
(c-4) enlarging the at least one sub-video on the displaying area.
